(19) United States
(12) Patent Application Publication
(10) Pub. No.: US 2001/0048053 A1
(43) Pub. Date: Dec. 6, 2001

(54) WIRE SUPPORT BRACKET FOR USE IN ELECTRICAL SYSTEMS FOR REPELLING BIRDS

(75) Inventor: BRUCE A. DONOHO, MISSION VEJO, CA (US)

Correspondence Address: LEONARD TACHER, A PROFESSIONAL LAW CORPORATION, 17961 Sky Park Circle, Suite 38-E, IRVINE, CA, 92614-6364, US

(73) Assignee: LEONARD TACHNER

(21) Appl. No.: 09/317,302

(22) Filed: May 24, 1999

(51) Int. Cl. F16L 3/22

(52) U.S. Cl. 248/68.1

(57) ABSTRACT

A bracket insulator is designed to provide support for wires carrying electrical current to repel birds. Each bracket is configured for receiving a wire in a slotted hole. There are five such slotted holes in the preferred embodiment. Thus the bracket provides for holding up to five parallel wires in spaced relation. The spacing is selected to provide a high likelihood of shocking birds that land on the wires. The brackets provide additional slots for alternative wire mounting as well as a variety of holes for still other wire supporting paths. Bracket mounting holes are also provided.

### BACKGROUND OF THE INVENTION

1. Field of the Invention

The present invention relates generally to bird repellent devices and more specifically to a bracket for receiving a plurality of spaced parallel wires for repelling birds by means of electrical shock.

2. Prior Art

The presence of birds on window sills, roof tops, boat masts and covers and the like is often undesirable. Bird droppings attract insects and provide a fertile bed for bacteria which can present a significant health hazard. Additionally, the unaesthetic appearance of bird droppings and the like often requires the task of unpleasant and time consuming clean up where access to the droppings is available. Often times the repulsive appearance of bird droppings and other by-products of birds is not even accessible for clean up.

The use of wires carrying electrical current to repel birds is not new. Low voltage transformers connected to elongated exposed wires strung along surfaces to be protected from birds, provide a relatively simple way of dealing with the bird dropping problem. However, in order to make such electrical shocking installations operate properly, wires must be both parallel over their entire lengths and relatively close together so that their spacing permits a bird's foot to span at least two adjacent wires, a prerequisite for generating an electrical shock. There is a need for devices which permit easy installation of long parallel wires set close to one another. Such devices should be low cost and easily installed so that as many as necessary may be used over long stretches of bird repellent wires without materially increasing cost of materials or labor.

### SUMMARY OF THE INVENTION

The present invention comprises a unique bracket which meets the aforementioned need for permitting easy installation of long parallel wires set close to one another for repelling birds. The bracket is an injection molded plastic device which may be readily installed on an underlying surface at selected intervals. Each bracket comprises a plurality of spaced apart slotted holes for receiving press-fit wires. By installing the brackets at regular intervals, a plurality of long wires can be readily installed in the slotted holes which cause the wires to be held in parallel over long distances while the wires are spaced apart by the small distances between the slotted holes of the bracket.

### OBJECTS OF THE INVENTION

It is therefore a principal object of the present invention to provide a bracket for supporting, at regular intervals, a plurality of elongated electrical wires in parallel at selected distances from one another for repelling birds.

It is another object of the invention to provide a low cost bracket having regularly spaced slotted holes for supporting a plurality of electrical current carrying wires for repelling birds from elongated surfaces.

It is yet another object of the invention to provide an injection molded, stable bracket which may be readily secured to an underlying surface at spaced intervals to receive a plurality of parallel elongated electrical wires to repel birds by means of electrical shock.

It is yet another object of the invention to provide a bird repellant electrical wire bracket insulator having a plurality of slotted holes to receive current-carrying wires that are simply press-fit into the bracket.

### BRIEF DESCRIPTION OF THE DRAWINGS

The aforementioned objects and advantages of the present invention, as well as additional objects and advantages thereof will be more fully understood hereinafter as a result of a detailed description of a preferred embodiment when taken in conjunction with the following drawings in which:

FIG. 1 is a three-dimensional view of a preferred embodiment of the bracket of the invention;

FIG. 2 is a side view thereof;

FIG. 3 is a top view thereof;

FIG. 4 is a front view thereof;

FIG. 5 is an illustration of a typical installation of the invention; and

FIG. 6 is a three-dimensional view of an alternative embodiment of the invention.

### DETAILED DESCRIPTION OF A PREFERRED EMBODIMENT

Referring to the accompanying figures, it will be seen that the bracket 10 of the present invention comprises a planar rectangular member 12 compressed between a pair of spaced apart triangular members 14 and 16 and mounted perpendicularly on a base member 18. The base member comprises a plurality of mounting holes 20 for securing the bracket 10 to an underlying surface. Member 12 has a plurality of holes 24 and slots 28 leading from the edge 25 of the member to the holes 24. This slotted hole configuration permits a wire to be press fit into the hole 24 without feeding the wire through the hole directly. The holes 24 are preferably equally spaced from one another so that wires would be equally spaced from one another as well. Slots 22 in triangular members 14 and 16, permit the brackets to be used for support of other structures between brackets such as transformer platforms and the like.

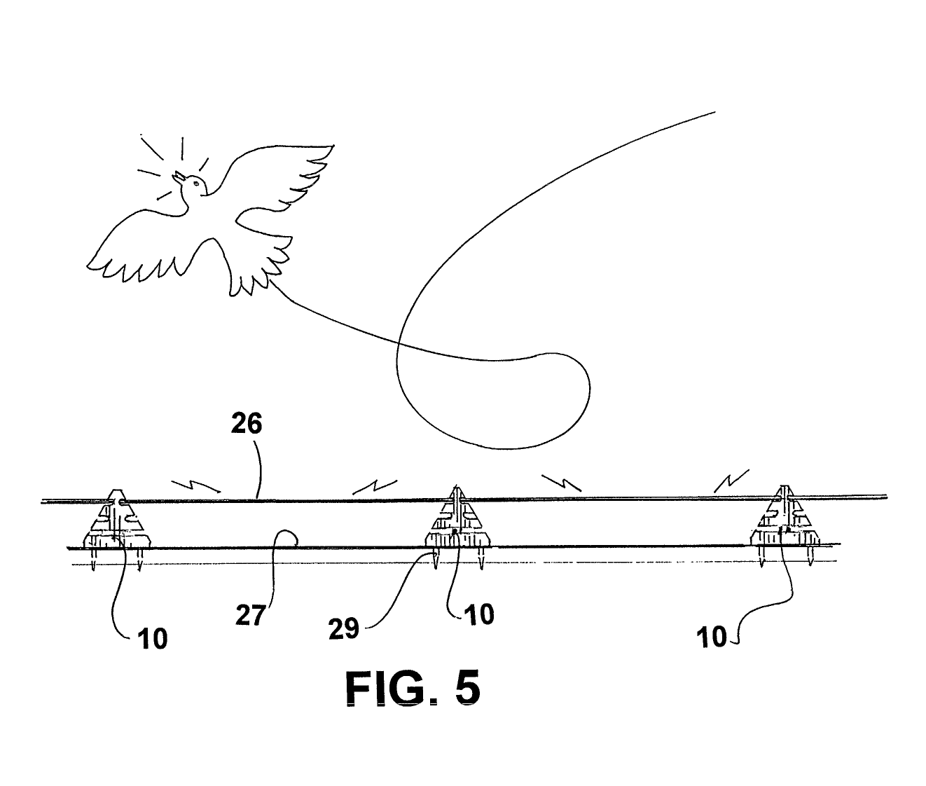

FIG. 5 illustrates a typical installation in which a plurality of brackets 10 are installed at regularly spaced intervals on an underlying surface 27 by fasteners 29. The brackets support a plurality of electrical wires 26 in parallel, spaced apart relation so that a bird landing on the wires receives an electrical shock and is thereby repelled.

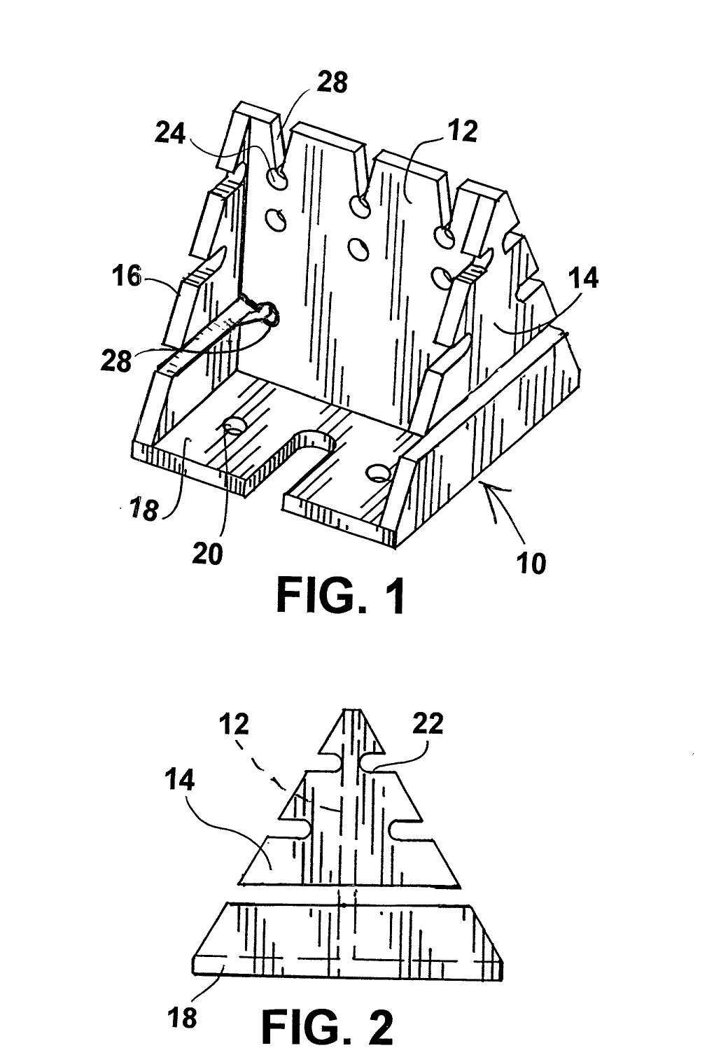

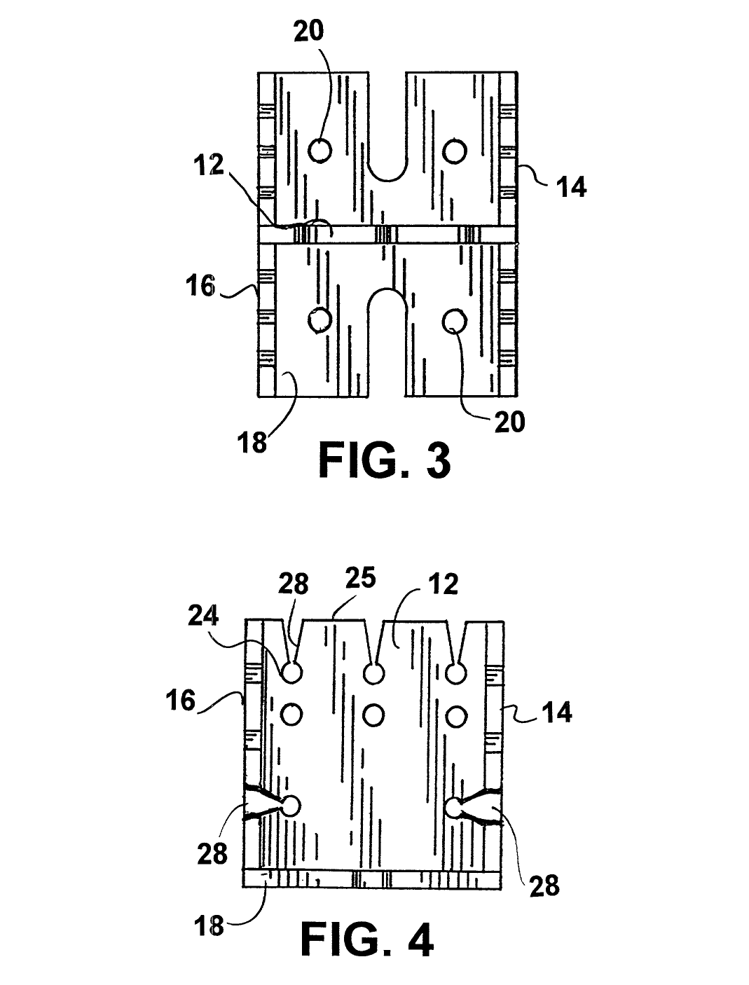

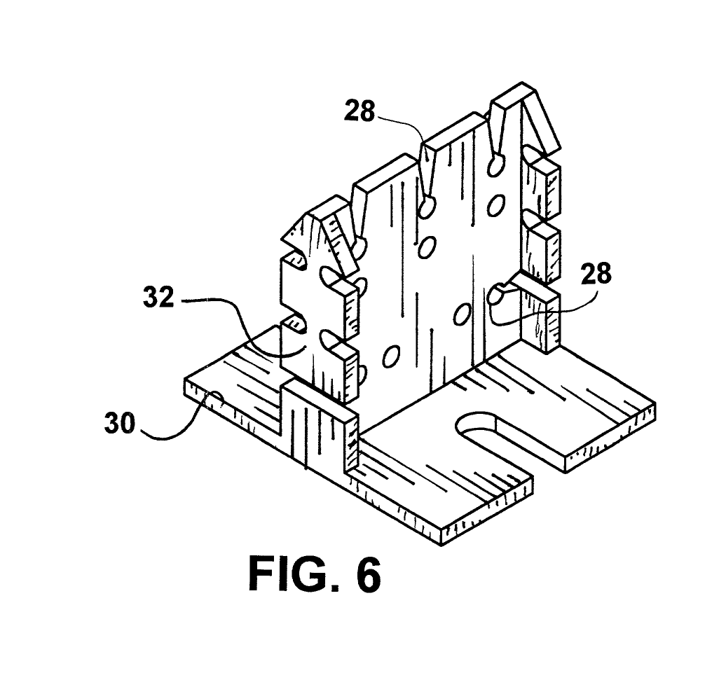

FIG. 6 illustrates an alternative embodiment of the bracket hereof. In FIG. 6, a bracket 30 is configured with smaller or less bulky side members 32 as compared to triangular members 14 and 16 of FIG. 1

Having thus disclosed a preferred, but exemplary embodiment, it being understood that many variations are contemplated as being within the scope hereof, what is claimed is:

1. A bracket for installation or an underlying surface and comprising a planar member having a plurality of spaced, slotted holes for receiving electrical wires in spaced parallel relation for shocking birds that land on said wires.

2. The bracket recited in claim 1 wherein said planar member is supported in a position that is substantially perpendicular to said underlying surface.

3. The bracket recited in claim 1 further comprising a base member supporting said planar member and having at least one hole for securing said bracket to said underlying surface.

4. The bracket recited in claim 3 further comprising a pair of side members sandwiching said planar member for stabilizing said planar member on said base member.

5. A bird repellant apparatus comprising a plurality of spaced brackets on an underlying surface, each such bracket having a plurality of slotted apertures for receiving a plurality of current carrying electrical wires in parallel spaced relation for shocking birds attempting to land on said wires.

6. The apparatus recited in claim 5 wherein each such bracket comprises an injection molded plastic material.
